(19) United States
(12) Patent Application Publication
(10) Pub. No.: US 2019/0023613 A1
(43) Pub. Date: Jan. 24, 2019

(54) Reaction Resin Composition, Multi-Component System and Use Thereof

(71) Applicant: Hilti Aktiengesellschaft, Schaan (LI)

(72) Inventors: Angel JIMENEZ, Muenchen (DE); Mickael GALLEF, Mulhouse (FR); Armin PFEIL, Kaufering (DE)

(21) Appl. No.: 16/064,941

(22) PCT Filed: Dec. 15, 2016
(86) PCT No.: PCT/EP2016/081106

§ 371 Date: Jun. 21, 2018

(30) Foreign Application Priority Data
Dec. 21, 2015 (EP) 15201471.8

(51) Int. Cl. C04B 28/02; C04B 40/00

(52) U.S. Cl. CPC C04B 28/02; C04B 2103/0067; C04B 40/0046

(57) ABSTRACT

Disclosed is a reaction resin composition comprising: a radically polymerizable compound; an initiator system having an a-halo carboxylic acid ester and a catalyst system containing a copper (II) salt, a reducing agent and at least one ligand containing nitrogen; a hydraulically curing compound; and water. Also disclosed is a two- or multi-component system containing said reaction resin composition and uses of said composition for construction applications.

This application claims the priority of International Application No. PCT/EP2016/081106, filed Dec. 15, 2016, European Patent Application No. 15201471.8, filed Dec. 21, 2015, the disclosures of which are expressly incorporated by reference herein.

The present invention relates to a radically curable reaction resin composition having a resin component, an initiator system, which comprises an initiator and a catalyst system, which is able to form a transition metal complex as a catalyst in situ, and a hydraulically curing compound, as well as the use of the composition for construction applications, particularly for anchoring anchoring elements in boreholes.

The use of reaction resin compounds based on unsaturated polyester resins or epoxy resins as adhesive and binding agents has been known for a long time. It thereby involves two-component systems, wherein one component contains the resin mixture and the other component contains the curing agent. Other conventional components, such as fillers, accelerants, stabilizers, solvents, including reactive solvents (reactive diluents) may be contained in the one and/or other component. By mixing the two components, the reaction is initiated while forming a cured product.

Mortars, which are to be used in chemical fastening technology, are complex systems subjected to special requirements, such as the viscosity of the mortar, curing and fully curing in a relatively broad temperature range, typically from −10° C. to +40° C., the inherent strength of the cured mortar, adhesion on various substrates and in various ambient conditions, load values, creep strength and similar.

Basically, chemical fastening technology makes use of two systems. One is based on radically polymerizable, ethylenically unsaturated compounds, which are generally cured with peroxides, and one is based on epoxy-amines

Organic, curable two-component reaction resin compositions based on curable epoxy resins and amine hardeners are used as adhesives, putties for filling cracks, and among other things for attaching construction elements, such as anchor rods, reinforcing iron (rebar), screws and similar in boreholes. Such mortars are known for example from EP 1 475 412 A2, DE 198 32 669 A1 and DE 10 2004 008 464 A1.

One disadvantage of the known epoxy-based mortars is in the use of often substantial quantities of caustic amines as hardeners, such as xylylene diamine (XDA), particularly m-xylylene diamine (mXDA; 1,3-benzenedimethanamine), and/or aromatic alcohol compounds, such as free phenols, e.g., bisphenol A, which can pose a health risk for users. The compounds are contained in partly substantial quantities, i.e., up to 50% in the respective components of multi-component mortars, so that often the packaging requires mandatory labeling, which results in lower acceptance of the product by users. In the last few years, some countries introduced limits as to what content of mXDA or bisphenol A may be contained in the products and must then be labeled or may even still be allowed in products.

Radically curable systems, particularly systems curable at room temperature, require so-called radical starters, also known as initiators, so that the radical polymerization can be triggered. In the field of chemical fastening technology, the curing composition described in application DE 3226602 A1, comprising benzoyl peroxide as a radical starter and an aminic compound as an accelerant, and the curing composition described in application EP 1586569 A1, comprising a perester as a hardener and a metal compound as an accelerant, have established themselves based on their properties. These hardener compositions allow fast and quite complete curing even at very low temperatures down to −30° C. In addition, these system are robust in terms of the resin and hardener mixing ratios. Thus, they are suited for use under construction site conditions.

However, a disadvantage of these resin compositions is that in both cases peroxides must be used as radical starters. These are thermally sensitive and are very sensitive to contamination. This results in substantial limitations in the formulation of pasty hardener components especially for injection mortars in regard to storage temperatures, storage stability, and the selection of suitable components. To enable the use of peroxides, such as dibenzoyl peroxide, peresters and similar, phlegmatizing agents, such as phthalates or water, are added for their stabilization. These act as softeners and thereby significantly influence the mechanical strength of the resin mixtures.

Furthermore, these known hardener compositions are disadvantageous to the extent that they must contain substantial peroxide quantities, which is problematic because peroxide-containing products, starting at a concentration of 1%, such as for dibenzoyl peroxide, require sensibilizing labeling in certain countries. This also applies similarly to aminic accelerants, some of which also require mandatory labeling.

To date, only few tests have been conducted to develop peroxide-free systems on the basis of radically polymerizable compounds. A peroxide-free resin composition for radically polymerizable compounds is known from DE 10 2011 078 785 A1 and it contains a 1,3-dicarbonyl compound as a hardener and a manganese compound as an accelerant, as is their use for reaction resin compositions based on radically curable compounds. However, this system tends to not fully cure sufficiently under certain conditions, which can result in a diminished effectiveness of the cured mass, especially for the application as a plugging compound, so that here an application for plugging compounds is generally possible, but not for those applications in which fairly high load values are reliably required.

In regard to the two described systems, another disadvantage is that for each one a defined ratio of resin component and hardener component (hereinafter also referred to as “mixing ratio” for short) must be complied with, so that the binding agents harden completely and the required properties of the cured masses can be achieved. Many of the known systems are less robust in regard to the mixing ratio and are partly quite sensitive to mixing fluctuations, which is reflected in the properties of the cured masses.

Another possibility to initiate a radical polymerization without using peroxides is provided by the ATRP (=Atom Transfer Radical Polymerization) process frequently used in macromolecular synthetic chemistry. It is assumed that it hereby involves a “living” radical polymerization, without a limitation occurring due to the description of the mechanism [sic]. In this process, a transition metal compound is reacted with a compound, which has a transferable atom group. The transferable atom group is hereby transferred to the transition metal compound, by means of which the metal is oxidized. In this reaction, a radical is formed, which adds to ethylenically unsaturated groups. The transfer of the atom group to the transition metal compound is reversible however, so that the atom group is transferred back to the growing polymer chain, by means of which a controlled polymerization system is formed. This reaction process is described by J-S. Wang, et al., J. Am. Chem. Soc., vol. 117, p. 5614-5615 (1995) and by Matyjaszewski, Macromolecules, vol. 28, p. 7901-7910 (1995). In addition, the publications WO 96/30421 A1, WO 97/47661 A1, WO 97/18247 A1, WO 98/40415 A1 and WO 99/10387 A1 disclose variants of the previously explained ATRP.

ATRP was of scientific interest for a long time and is essentially used to control the properties of polymers in a targeted manner and to adapt them to desired applications. These include the control of particle size, the structure, length, weight and weight distribution of polymers. Accordingly, the structure of the polymer, the molecular weight and the molecular weight distribution can be controlled. As a result, ATRP is gaining in scientific interest. For example, U.S. Pat. Nos. 5,807,937 and 5,763,548 describe (co)polymers, which were produced by means of ATRP and are useful for a variety of applications, such as dispersing agents and surface-active substances.

However, the ATRP process has not been used to date to carry out polymerization on site, such as at the construction site under the conditions prevailing there, as is required for construction-related applications, e.g., mortars, adhesives, and plugging compounds. The requirements placed on the polymerizable compositions in these applications, namely initiating polymerization in a temperature range between −10° C. and +60° C., inorganically filled compositions, adjusting a gel time with subsequent fast and the most complete polymerization of the resin component possible, the manufacture as single- or multi-component systems and the other known requirements placed on the cured material, have not been taken into account to date in the extensive literature on the topic of ATRP.

Therefore, the object of the invention is to provide a reaction resin composition for mortar systems of the type described earlier, which does not have the mentioned disadvantages of the known systems, which can be manufactured in particular as a two-component system, is storage-stable for months, and reliably cures, i.e., is cold-curing, at conventional application temperatures for reaction resin mortars, i.e., between −10° C. and +60° C.

A reaction resin composition is known from EP 2 824 155 A1 having a [sic] resin component, which contains a radically polymerizable compound, and an initiator system, which contains an α-halocarboxylic acid ester and a catalyst system, which comprises a copper(I) salt and at least one nitrogen-containing ligand. A disadvantage of this composition is that for the reducing agent required for the in situ reduction of the copper(II) salt, only those reducing agents can be used, which are soluble in the reaction resin used and if applicable the reactive diluents used.

From this emerges the objective to provide a reaction resin composition for mortar systems of the type described earlier, which permits the use of additional reducing agents and thus a higher degree of freedom in formulating the composition, which does not impair the storage stability or interfere with the reliable curing at conventional temperatures for reaction resin mortars, i.e., between −10° C. and +60° C.

The inventor surprisingly discovered that this objective can be achieved by using a two- or multi-component inorganic/organic hybrid system with ATRP initiator systems as a radical initiator for the previously described reaction resin compositions based on radically polymerizable compounds, wherein the radical initiator and the reducing agent are at least partially dissolved in water or are present in an emulsified state, and wherein a hydraulically curing compound is used as the inorganic ingredient.

To better understand the invention from the outset, the following explanations of the terminology used herein are considered to be helpful. For the purposes of the invention:
“cold-curing” means that the polymerization, herein also referred to synonymously as “curing,” of the two curable compounds can be started at room temperature, without an additional energy input, such as supplying heat, by the curing agents contained in the reaction resin compositions, if applicable in the presence of accelerants, and also exhibit sufficient curing for the planned application purposes;
“separated in a reaction-inhibiting manner” means that a separation between compounds or components is achieved in such a manner that a reaction among them can first occur when the compounds or components are brought into contact with each other, such as by mixing; a reaction-inhibiting separation is also conceivable by means of a (micro-) encapsulation of one or more compounds or components;
“curing agent” refers to materials, which effect the polymerization (curing) of the base resin;
“aliphatic compound” refers to an acyclic and cyclic, saturated or unsaturated hydrocarbon compound that is not aromatic (PAC, 1995, 67, 1307; Glossary of class names of organic compounds and reactivity intermediates based on structure (IUPAC Recommendations 1995));
“accelerant” refers to a compound able to accelerate the polymerization reaction (curing), which serves to accelerate the formation of the radical starter;
“polymerization inhibitor,” referred to herein also as an “inhibitor,” is a compound able to inhibit the polymerization reaction (curing), used to prevent the polymerization reaction and thus an undesired premature polymerizing of the radically polymerizable compound while in storage (often referred to as a “stabilizer”) and that serves to delay the start of the polymerization reaction directly after adding the curing agent; to achieve the purpose of storage stability, the inhibitor is typically used in such low quantities that the gel time is not influenced; to influence
the start time of the polymerization reaction, the inhibitor is usually used in such quantities that the gel time is influenced;
“reactive diluents” refer to liquid or low-viscosity monomers and base resins, which dilute other base resins or the resin ingredient, and thereby provide the viscosity required for their application, contain functional groups able to react with the base resin, and for the most part become a component of the cured material (mortar) during polymerization (curing).
“gel time” for unsaturated polyester or vinyl resins that are usually cured with peroxides corresponds to the time of the curing phase of the resin the gel time [sic] in which the temperature of the resin increases from +25° C. to +35° C.; this corresponds approximately to the period in which the fluidity or the viscosity of the resin is still in such a range that the reaction resin or the reaction resin material can still be processed and machined;
“two-component system” is a system that comprises two separately stored components, generally a resin and hardener component, so that curing of the resin component first occurs after mixing both components;
“multi-component system” is a system that comprises three or more separately stored components, so that curing of the resin component first occurs after mixing all components;
“(Meth)acryl . . . l . . . (meth)acryl . . . ,” which shall include both the “methacryl . . . / . . . methacryl . . . ”—as well as the “acryl . . . / . . . acryl . . . ”—compounds;
“hydraulically curing” means that a compound, the binding agent, cures with water and thereby cures;
“polycondensable” means that inorganic compounds form polymer structures in a curing manner in other ways than with water, and thereby harden

The inventor discovered that under the prevailing reaction conditions found in construction applications, radically polymerizable compounds can be polymerized with a combination of certain compounds, as they are used for initiating ATRP. In this way, it is possible to provide a reaction resin composition, which is cold-curing, which meets the requirements placed on reaction resin compositions for use as mortar, adhesive or putty materials, and which is storage-stable, particularly as a two- or multi-component system.

Furthermore, the inventor surprisingly discovered that it is possible to have radically polymerizable compounds polymerized using an aqueous component, which contains a water-soluble reducing agent and a partially dissolved or partially emulsified initiator, under reaction conditions that prevail in construction applications.

Therefore, a first subject matter of the invention is a reaction resin composition with a radically polymerizable compound having an initiator system, which contains an α-halocarboxylic acid ester and a catalyst system, which comprises a copper(II) salt, a reducing agent and at least one nitrogen-containing ligand, having a hydraulically curing and/or polycondensable compound and water, wherein the copper(II) salt is separated in a reaction-inhibiting manner from the reducing agent, and wherein the water is separated in a reaction-inhibiting manner from the hydraulically curing and/or polycondensable compound.

According to the invention, the initiator system comprises an initiator and a catalyst system.

The initiator is for practical purposes a compound, which has a halogen-carbon bond, which produces C radicals through a catalytic homolytic cleavage, said C radicals able to start a radical polymerization. To ensure a sufficiently long lifespan of the radical, the initiator must have substituents, e.g., carbonyl substituents, which can stabilize the radical. The halogen atom exerts additional influence on the initiation.

The primary radical formed from the initiator preferably has a similar structure as the radical center of the growing polymer chain. In other words, if the reaction resin compositions involve methacrylate resins or acrylate resins, α-halocarboxylic acid esters of the isobutyric acid or the propanoic acid are particularly well suited. However, on a case-by-case basis, the particular suitability should always be determined by means of testing.

An advantage of the composition according to the invention, which contains water, is that α-halocarboxylic acid esters can also be used, which are not soluble in water but can at least be emulsified, as long as the initiator dissolves well in radically polymerizable compounds and/or, if applicable, the reactive diluents used. The latent risk of hydrolysis, i.e., the nucleophile substitution of the bromide ion by a hydroxide ion, can be decreased, by means of which one can improve the storage stability of the composition.

For the application of the reaction resin composition as a construction-related adhesive, mortar or putty material, particularly for mineral substrates, a compound class has proven itself to be particularly well-suited for the task. Thus, according to the invention, the initiator is a α-halocarboxylic acid ester having the general formula (I)

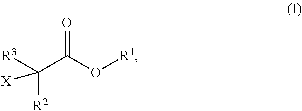

in which

X refers to chlorine, bromine or iodine, preferably chlorine or bromine, most preferably bromine;

R1 stands for a straight-chained or branched, optionally substituted C1-C20 alkyl group, preferably a C1-C10 alkyl group, a polyalkylene oxide chain or group or an aryl group; or

for the residue of an acylated, branched, trivalent alcohol, the residue of a completely or partially acylated, linear or branched, tetravalent alcohol, the residue of a completely or partially acylated, linear pentavalent or hexavalent alcohol, the residue of a completely or partially acylated, linear or cyclic C4-C6 aldoses or C4-C6 ketoses or the residue of a completely or partially acylated disaccharide, and isomers of these compounds;

R2 and R3 stand, independently of each other, for hydrogen, a C1-C20 alkyl group, preferably a C1-C10 alkyl group, and more preferred a C1-C6 alkyl group, or a C3-C8 cyclo-alkyl group, C2-C20 alkenyl or alkinyl group, preferably a C2-C6 alkenyl group or alkinyl group, oxiranyl group, glycidyl group, aryl group, heterocyclyl group, aralkyl group, [or] aralkenyl group (aryl-substituted alkenyl groups).

Such compounds as well as their manufacture are known to a person skilled in the art. In this regard, reference is made to publications WO 96/30421 A1 and WO 00/43344 A1, whose content is hereby incorporated in this application.

Suitable initiators comprise for example C1-C6 alkyl esters of α-halo-C1-C6 carbonic acid, such as α-chloropropionic acid, α-bromopropionic acid, α-chloro-iso-butyric acid, α-bromo-iso-butyric acid and the like.

Esters of α-bromo-iso-butyric acid are preferred. Examples of suitable α-bromo-iso-butyric acid esters are: bis[2-(2′-bromo-iso-butyryloxy)ethyl]disulfide, bis[2-(2-bromo-iso-butyryloxy)undecyl]disulfide, α-bromo-iso-butyryl bromide, 2-(2-bromo-iso-butyryloxy)ethyl methacrylates, tert-butyl-α-bromo-iso-butyrate, 3-butynyl-2-bromo-iso-butyrate, dipentaerythritol hexakis(2-bromo-iso-butyrate), dodecyl-2-bromo-iso-butyrate, ethyl-α-bromo-iso-butyrate, ethylene bis(2-bromo-iso-butyrate), 2-hydroxyethyl-2-bromo-iso-butyrate, methyl-α-bromo-iso-butyrate, octadecyl-2-bromo-iso-butyrate, pentaerythritol tetrakis(2-bromo-iso-butyrate), poly(ethylene glycol)bis(2-bromo-iso-butyrate), poly(ethylene glycol)methylether-2-bromo-iso-butyrate, 1,1,1-tris(2-bromo-iso-butyryloxymethyl)ethane, and 10-undecenyl 2-bromo-iso-butyrate.

The catalyst is a catalyst system with multiple components. The actual catalyst is a copper(I) compound, that is produced in situ for the purposes of storage stability. According to the invention, the catalyst system consists of a copper(II) salt, a suitable reducing agent and at least one ligand.

For practical purposes, the copper must participate in a single-electron redox process, have a high affinity for a halogen atom, especially bromine, and it should be able to reversibly increase its coordination number by one. Furthermore, it should tend to form a complex.

For practical purposes, the ligand contributes to the solubility of the copper salt in the radically polymerizable compound to be used, to the extent the copper salt itself is not yet soluble and can adjust the redox potential of the copper in regard to reactivity and halogen transfer.

So that radicals can be cleaved from the initiator, which initiate the polymerization of the radically polymerizable compounds, a compound is required, which allows or controls, or in particular accelerates the cleaving. With a suitable compound, it becomes possible to provide a reaction resin mixture that cures at room temperature.

For practical purposes, this compound is a suitable transition metal complex, which can homolytically cleave the bond between the α-carbon atom and the initiator's halogen atom attached to it. Furthermore, the transition metal complex must be able to participate in a reversible redox cycle with the initiator, a dormant polymer chain end, a growing polymer chain end or a mixture thereof.

This compound is a copper(I) complex having the general formula Cu(I)—X-L, which is formed from a copper(I) salt and a suitable ligand (L). However, copper(I) compounds are often very oxidation-sensitive, wherein they can already be converted into copper(II) compounds by atmospheric oxygen.

If the reaction resin mixture is produced directly prior to their use, i.e., their components are mixed, the use of copper(I) complexes is generally not critical. However, if a storage-stable reaction resin mixture is to be provided over a certain period, this will depend considerably on the stability of the copper(I) complex in relation to atmospheric oxygen or other components possibly contained in the reaction resin mixture.

To provide a storage-stable reaction resin mixture, it is therefore necessary to use the copper salt in a stable form. Accordingly, the copper(I) complex is formed in situ from a copper(II) salt and a suitable ligand. To that end, the initiator system also contains a suitable reducing agent, wherein the copper(II) salt and the reducing agent are preferably separated from each other in a reaction-inhibiting manner.

Suitable copper(II) salts are those that are either at least partially soluble in the radically polymerizable compound used, [in] a solvent possibly added to the resin mixture, such as reactive diluents, and/or in water. Such copper(II) salts are for example Cu(II)(PF6)2, CuX2, where X=CI, Br, I, wherein CuX2 is preferred and CuCI2 or CuBr2 is more preferred, Cu(OTf)2 (—OTf=trifluoromethanesulfonate, CF3 S03-) or Cu(ll)-carboxylate. Particularly preferred are those copper(II) salts, which depending on the radically polymerizable compound used, are at least partially soluble in it or in water without adding a ligand.

To form the copper(I) complex when a copper(II) salt is utilized as explained above, a reducing agent is used that can reduce the copper(II) in situ to a copper(I).

According to the invention, the reducing agent is water soluble. Reducing agents, which essentially allow the reduction without forming radicals, which in turn can initiate new polymer chains, can be used as long as these are water-soluble. Suitable reducing agents are for example ascorbic acid and its derivatives, tin compounds, reducing sugars, e.g., fructose, antioxidants, such as those used for preserving food, e.g., flavonoids (quercetin), β-carotenoids (vitamin A), α-tocopherol (vitamin E), phenolic reducing agents, such as propyl or octyl gallate (triphenol), butylhydroxyanisole (BHA) or butylhydroxytoluene (BHT), other food preservation agents, such as nitrites, propionic acids, sorbic acid salts or sulfates. Additional suitable reducing agents are SO2, sulfites, bisulfites, thiosulfates, mercaptanes, hydroxylamines and hydrazine and derivates thereof, hydrazone and derivatives thereof, amines and derivates thereof, phenols and enols. The reducing agent can also be a transition metal M(0) in an oxidation state of zero. In addition, a combination of reducing agents can be used.

In this context, reference is made to U.S. Pat. No. 2,386,358, whose content is hereby incorporated in this application.

Preferably, the reducing agent is selected among ascorbic acid or its salts, as well as among bisulfites.

Suitable ligands, particularly neutral ligands, are known from the complex chemistry of transition metals. They are coordinated with the coordination center under the expression of various bond types, e.g., σ-, π-, μ, and η bonds. By selecting the ligand, one can adjust the reactiveness of the copper(I) complex in relation to the initiator as well as control or improve the solubility of the copper(I) salt.

According to the invention, the ligand is a nitrogen-containing ligand. For practical purposes, the ligand is a nitrogen-containing ligand, which contains one, two, or more nitrogen atoms, such as mono-, bi- or tridentate ligands.

Suitable ligands are amino compounds with primary, secondary and/or tertiary amino groups, of which those with exclusively tertiary amino groups are preferred, or amino compounds with heterocyclic nitrogen atoms, which are particularly preferred.

Examples of suitable amino compounds are: ethylene diaminotetraacetate (EDTA), N,N-dimethyl-N′,N′-bis(2-dimethylaminoethyl)ethylenediamine (Me6TREN), N,N′-dimethyl-1,2-phenylenediamine, 2-(methylamino)phenol, 3-(methylamino)-2-butanol, N,N′-bis(1,1-dimethylethyl)-1,2-ethanediamine or N,N,N′,N″,N″-pentamethyldiethylenetriamine (PMDETA,) and mono-, bi- or tridentate heterocyclic electron donor ligands, such as those derived from unsubstituted or substituted heteroarenes such as furan, thiophene, pyrrole, pyridine, bipyridine, picolylimine, γ-pyran, γ-thiopyran, phenanthroline, pyrimidine, bis-pyrimidine, pyrazine, indole, coumarin, thionaphthene, carbazole, dibenzofuran, dibenzothiophene, pyrazole, imidazole, benzimidazole, oxazole, thiazole, bis-thiazole, isoxazole, isothiazole, quinoline, biquinoline, isoquinoline, biisoquinoline, acridine, chromane, phenazine, phenoxazines, phenothiazine, triazine, thianthrene, purine, bismidazole and bisoxazoline.

Preferred among them are 2,2′-bipyridine, N-butyl-2-pyridylmethanimine, 4,4′-di-tert-butyl-2,2′-dipyridine, 4,4′-dimethyl-2,2′-dipyridine, 4,4′-dinonyl-2,2′-dipyridine, N-dodecyl-N-(2-pyridylmethylene)amine, 1,1,4,7,10,10-hexamethyl-triethylentetramine, N-octadecyl-N-(2-pyridylmethylene)amine, N-octyl-2-pyridylmethanimine, N,N,N′,N″,N″-pentamethyl-diethylentriamine, 1,4,8,11-tetracyclotetradecane, N,N,N′,N′-tetrakis(2-pyridylmethyl)ethylenediamine, 1,4,8,11-tetramethyl-1,4,8,11-tetraazacyclotetradecane, tris[2-(diethylamino)ethyl]amine or tris(2-methylpyridyl)amine, wherein N,N,N′,N″,N″-pentamethyldiethyltriamine (PMDETA), 2,2′-bipyridine (bipy) or phenanthroline (phen) are more preferred.

Contrary to the recommendations from scientific literature, which generally describes a ratio of Cu:ligand=1:2 for the quantity of nitrogen-containing ligands to be used, the inventor surprisingly discovered that the reaction resin composition exhibits significantly stronger reactivity, i.e., cures faster and fully cures better, when the nitrogen-containing ligand is used in excess. “In excess” hereby means that the amine ligand is definitely used in a ratio of Cu:ligand=1:5, or even up to 1:10. What is relevant is that in turn this excess does not have a detrimental impact on the reaction and the final properties.

Also contrary to the recommendations from scientific literature, the inventor surprisingly discovered that the reaction resin composition exhibits a significantly stronger reactivity regardless of the quantity used, when the ligand is a nitrogen-containing compound with primary amino groups.

Accordingly, the nitrogen-containing ligand in a highly preferred embodiment is an amine with at least one primary amino group. The amine is for practical purposes a primary amine, which can be aliphatic, including cycloaliphatic, aromatic and/or araliphatic, and can carry one or more amino groups (hereinafter referred to as a polyamine). The polyamine preferably carries at least two primary aliphatic amino groups. Furthermore, the polyamine can also carry amino groups, which have secondary or tertiary characters. Polyaminoamides and polyalkyleneoxide-polyamines or amine adducts, such as amine-epoxy resin adducts or Mannich bases are also just as suitable. Araliphatic refers to amines, which contain both aromatic as well as aliphatic residues.

Without limiting the scope of the invention, suitable amines are for example: 1,2-diaminoethane (ethylenediamine), 1,2-propanediamine, 1,3-propanediamine, 1,4-diaminobutane, 2,2-dimethyl-1,3-propanediamine (neopentanediamine), diethylaminopropylamine (DEAPA), 2-methyl-1,5-diaminopentane, 1,3-diaminopentane, 2,2,4- or 2,4,4-trimethyl-1,6-diaminohexane and mixtures thereof (TMD), 1-amino-3-aminomethyl-3,5,5-trimethylcyclohexane, 1,3-bis (aminomethyl) cyclohexane, 1,2-bis (aminomethyl) cyclohexane, hexamethylene diamine (HMD), 1,2- and 1,4-diaminocyclohexane (1,2-DACH and 1,4-DACH), bis (4-aminocyclohexyl) methane, bis (4-amino-3-methylcyclohexyl) methane, diethylenetriamine (DETA), 4-azaheptane-1,7-diamine, 1,11-diamino-3,6,9-trioxundecan, 1,8-diamino-3,6-dioxaoctane, 1,5-diamino-methyl-3-azapentane, 1,10-diamino-4,7-dioxadecane, bis (3-aminopropyl) amine, 1,13-diamino-4,7,10-trioxatridecane, 4-aminomethyl-1,8-diaminooctane, 2-butyl-2-ethyl-1,5-diaminopentane, N, N-bis (3-aminopropyl) methylamine, triethylenetetramine (TETA), tetraethylenepentamine (TEPA), pentaethylenehexamine (PEHA), bis (4-amino-3-methylcyclohexyl) methane, 1,3-benzene dimethanamine (m-xylylenediamine, MXDA), 1,4-benzene dimethanamine (p-xylylenediamine, PXDA), 5-(aminomethyl) bicycle [[2.2.1]hept-2-yl] methylamine (NBDA norbornanediamine), dimethyldipropylenetriamine, dimethylaminopropyl-aminopropylamine (DMAPAPA), 3-aminomethyl-3,5,5-trimethylcyclohexylamine (isophoronediamine (IPD)), diaminodicyclohexylmethane (PACM), mixed polycyclic amines (MPCA) (such as ANCAMINE® 2168), dimethyldiaminodicyclohexylmethane (Laromin® C260), 2,2-bis(4-aminocyclohexyl), [and] (3(4), 8(9)-bis(aminomethyl)dicyclo[5.2.1.02,6]decane (mixture of isomers, tricyclic primary amines; TCD-diamine).

Preferred are polyamines, such as 2-methylpentane (DYTEK A®), 1-amino-3-aminomethyl-3,5,5-trimethylcyclohexane (IPD), 1,3-benzene dimethanamine (m-xylylenediamine, MXDA), 1,4-benzene dimethanamine (p-xylylenediamine, PXDA), 1,6-diamino-2,2,4-trimethylhexane (TMD), diethylenetriamine (DETA), triethylenetetramine (TETA), tetraethylenepentamine (TEPA), pentaethylenehexamine (PEHA), N-ethylaminopiperazine (N-EAP), 1,3-bisaminomethylcyclohexane (1,3-BAC), (3(4),8(9)bis(aminomethyl)dicyclo [5.2.1.02,6] decane (mixture of isomers, tricyclic primary amines; TCD diamine), 1,14-diamino-4,11-dioxatetradecane, dipropylenetriamine, 2-methyl-1,5-pentanediamine, N,N′-di cyclohexyl-1,6-hexanediamine, N,N′-dimethyl-1,3-diaminopropane, N,N′-diethyl-1,3-diaminopropane, N,N-dimethyl-1,3-diaminopropane, secondary polyoxypropylene di- and triamine, 2,5-diamino-2,5-dimethylhexane, bis-(aminomethyl)tricyclopentadiene, 1,8-diamino-p-menthane, bis-(4-amino-3,5-dimethylcyclohexyl)methane, 1,3-bis (aminomethyl) cyclohexane (1,3-BAC), dipentylamine, N-2-(aminoethyl) piperazine (N-AEP), N-3-(aminopropyl) piperazine, [and] piperazine.

The amine can either be used alone or as a mixture of two or more of these.

According to the invention, the composition contains at least one hydraulically curing or polycondensable compound. This compound is initially used to bind water from the aqueous components. In addition, the presence of the hydraulically curing and/or polycondensable compound has other positive properties on the composition. It has been shown that the compositions according to the invention, even if they contain the curable compounds of totally different material classes in a mixture, still have an extraordinarily favorable storage-capability. Another advantage of the composition according to the invention consists, among other things, of the reduced shrinking tendency, the increased heat-related shape retention, improved fire behavior, resistance to climatic conditions, higher bond strength, more favorable expansion coefficient (more for concrete/steel), long-term behavior, [and] temperature-change resistance. Due to the high wetting capability, the complication-free usability in wet and/or dusty boreholes is particularly favorable. Generally, a particularly favorable strength and adhesion are thereby achieved on the borehole wall.

Preferably, cements, particularly aluminate cement, are used as curable, hydraulically curing compounds. Such aluminate cements contain primarily calcium aluminate compounds, for example monocalcium aluminate and/or bicalcium aluminate, as reactive compounds, wherein other amounts, for example aluminum oxide, calcium aluminate silicates and ferrites are possible. The analytic Al₂O₃ values are frequently, if not necessarily, above 35%. Quite generally, iron oxide-free or low-iron oxide cements have largely proven themselves, i.e., cements whose iron oxide contents are below approx. 10% by weight, particularly below 5% by weight, and most preferred below 2 or 1% by weight. For example, blast furnace cements with their low iron oxide content have proven themselves in addition to or instead of aluminate cements. Gypsum is another example of hydraulically curing compounds, which are usable within the scope of the present invention. Gypsum/cement mixtures are only possible when using cements, which have a high resistance to sulfates.

Inorganic materials, which polycondense in the presence of water or aqueous solutions, include preferably silicatic materials, particularly based on soluble and/or finely particulate, amorphous SiO₂, wherein the SiO₂ can be partly substituted, e.g., up to 50% by weight, by Al₂O₃. The materials may contain alkali hydroxides, particularly NaOH and/or KOH, alkali silicates, namely the water glass-type and/or meta-kaolinite, wherein the hydroxides and/or silicates can also be used as aqueous preparations for curing purposes. Materials of this type are described for example in EP-0 148 280 B1, which is hereby usably referred to within the meaning of the invention.

In a preferred embodiment of the invention, the reaction resin composition contains additional low-viscosity, radically polymerizable compounds as reactive diluents for the radically polymerizable compound, to adjust their viscosity if necessary.

Suitable reactive diluents are described in the publications EP 1 935 860 A1 and DE 195 31 649 A1. Preferably, the resin mixture contains a (meth)acrylic acid ester as a reactive diluent, wherein in a particularly preferred manner, (meth)acrylic acid esters are selected from the group consisting of hydroxypropyl(meth)acrylate, 1,3-propanediol di(meth)acrylate, butanediol-1,2 acrylate di(meth)acrylate, trimethylolpropane tri(meth)acrylate, 2-ethylhexyl(meth)acrylate, phenylethyl(meth)acrylate, tetrahydrofurfuryl(meth)acrylate, ethyl triglycol(meth)acrylate, N,N-dimethylaminoethyl(meth)acrylate, N,N-dimethylaminomethyl(meth)acrylate, 1,4-butanediol di(meth)acrylate, acetoacetoxyethyl(meth)acrylate, 1,2-ethanediol di(meth)acrylate, isobornyl(meth)acrylate, diethylene glycol di(meth)acrylate, methoxypolyethylene glycol(meth)acrylate, trimethylcyclohexyl(meth)acrylate, 2-hydroxyethyl(meth)acrylate, dicyclopentenyloxyethyl(meth)acrylate and/or tricyclopentadienyldi(meth)acrylate, bisphenol A di(meth)acrylate, Novolac epoxy di(meth)acrylate, di-[(meth)acryloyl maleoyl] tricyclo-5.2.1.0.2.6-decane, dicyclopentenyl-oxyethylcrotonate, 3-(meth)acryloyl-oxymethyl-tricylo-5.2.1,0.2.6-decane, 3-(meth)cyclopentadienyl(meth)acrylate, isobornyl(meth)acrylate, and decalyl-2-(meth)acrylate.

Basically, other conventional radically polymerizable compounds can be used alone or in a mixture with the (meth)acrylic acid esters, e.g., styrene, α-methylstyrene, alkylated styrenes, such as tert-butylstyrene, divinylbenzene, and allyl compounds.

In a preferred embodiment, a water-soluble reactive diluent is used, such as hydroxyethylmethacrylate, hydroxypropyl methacrylate, polyethylene glycol-mono- or -di-methacrylate. The water content can hereby be reduced without impairing the positive properties of the composition and their advantages. One can also hereby prevent that the robustness of the composition is impaired, particularly decreased, due to an excessively high water content. It is possible to substitute water by half with a water-soluble reactive diluent. Furthermore, a water-soluble reactive diluent has the advantage that one can optionally omit the tenside.

In an additional embodiment of the invention, the reaction resin composition also contains an inhibitor, particularly a non-phenolic inhibitor.

Suited as inhibitors both for storage stability of the radically polymerizable compound and thus also the resin component as well as to adjust the gel time are the stable radicals, such as N-oxyl radicals, generally used as inhibitors for radically polymerizable compounds, as they are known to a person skilled in the art. Phenolic inhibitors, as they are otherwise commonly used in radically curable resin compositions, cannot be utilized here, since the inhibitors would react as reducing agents with the copper(II) salt, which would have a disadvantageous effect on the storage stability and the gel time.

As N-oxyl radicals, one can use for example those as they are described in DE 199 56 509 A1. Suitable stable N-oxyl radicals (nitroxyl radicals) can be selected among 1-oxyl-2,2,6,6-tetramethylpiperidine, 1-oxyl-2,2,6,6-tetramethylpiperidine-4-ol (also referred to as TEMPOL), 1-oxyl-2,2,6,6-tetramethylpiperidine-4-one (also referred to as Tempon), 1-oxyl-2,2,6,6-tetramethyl-4-carboxyl-piperidine (also referred to as 4-carboxy TEMPON), 1-oxyl-2,2,5,5-tetramethylpyrrolidine, 1-oxyl-2,2,5,5-tetramethyl-3-carboxylpyrrolidine (also referred to as 3-carboxy-PROXYL), aluminum-N-nitrosophenylhydroxylamine, [and] diethylhydroxylamine. Further suitable N-oxyl compounds are oximes such as acetaldoxime, acetone oxime, methyl ethyl ketoxime, salicyloxime, benzoxime, glyoxime, dimethylglyoxime, acetone-0-(benzyloxycarbonyl) oxime, or indoline nitroxide radicals, such as 2,3-dihydro-2,2-diphenyl-3-(phenylimino)-1H-indol-1-oxylnitroxid, or β-phosphorylated nitroxide radicals, such as 1-(diethoxyphosphinyl)-2,2-dimethylpropyl-1,1-dimethylmethyl-nitroxide, and the like.

The reaction resin composition can also contain additional inorganic additives, such as fillers and/or additional additives.

As fillers, one can make use of conventional fillers, preferably mineral or mineral-like fillers, such as quartz, glass, sand, quartz sand, quartz powder, porcelain, corundum, ceramics, talcum, silicic acid (e.g., pyrogenic silicic acid), silicates, clay, titanium dioxide, chalk, barite, feldspar, basalt, aluminum hydroxide, granite or sandstone, polymer fillers, such as duroplasts, hydraulically curable fillers, such as gypsum, quicklime or cement (e.g., aluminous or Portland cement), metals, such as aluminum, carbon black, also wood, mineral or organic fibers, or similar, or mixtures of two or more of these, which can be added as powder, in granular form, or in the form of shaped bodies. The fillers can be in any form, for example as a powder or flour, or as formed bodies, e.g., in cylinder, ring, sphere, platelet, rodlet, saddle, or crystal form, or also in fiber form (fibrillary fillers), and the corresponding base particles preferably have a maximum diameter of 10 mm. However, the globular, inert materials (spherical form) have a preferred and significantly reinforcing effect.

Conceivable possible additives are thixotropic agents, such as possibly organic, post-treated pyrogenic silicic acid, bentonite, alkyl- and methyl cellulose, ricin oil derivatives or similar, softeners, such as phthalic acid or sebacic acid ester, stabilizers, antistatic agents, thickening agents, flexibilizers, curing catalysts, rheology adjuvants, wetting agents, coloring additives, such as coloring agents or particularly pigments, for example for the variable dyeing of components to better control their mixing, or similar, or mixtures of two or more of these. Non-reactive diluents (solvents) may also be present, such as low alkyl ketones, such as acetone, di-low alkyl-low

Alkanolamides, such as dimethylacetamide, low alkylbenzenes, such as xylenes or toluene, phthalic acid ester or paraffins, water or glycols. Furthermore, metal-scavenging agents in the form of surface-modified pyrogenic silicic acids may be contained in the reaction resin composition.

In this regard, reference is made to the publications WO 02/079341 A1 and WO 02/079293 A1 as well as WO 2011/128061 A1, whose content is hereby incorporated in this application.

To provide a storage-stable system, as already mentioned the copper(I) complex is first produced in situ, i.e., when mixing the corresponding reactants, out of a suitable copper(II) salt, the nitrogen-containing ligand and a suitable reducing agent. Accordingly, it is necessary to separate the copper(II) salt and the reducing agent in a reaction-inhibiting manner. This typically occurs by the copper(II) salt being placed in a first component and the reducing agent in a second component separate from the first component. Furthermore, the water-containing component, in other words the aqueous solution of the reducing agent and the aqueous solution or the emulsion of the initiator in water, must be stored separately from the hydraulically curing and/or polycondensable compound.

Accordingly, an additional subject matter of the invention is a two- or multi-component system, which contains the described reaction resin composition.

To provide a storage-stable system, it is necessary to spatially arrange the components of the reaction resin composition in such a manner that the curable components do not begin to harden prematurely, i.e., before their application. To this end and firstly, when using the hydraulically curing compound or the polycondensable compound, or a combination of these, both must be stored separately from the water in a reaction-inhibiting manner. Secondly, the polymerization of the radically polymerizable compound must be prevented. This can be achieved by the copper(II) salt being present but separated from the reducing agent in a reaction-inhibiting manner. This prevents the reactive species, namely the reactive copper(I) complex, from forming and thus already initiating polymerization of the radically polymerizable compound while in storage. The separation is achieved by the ingredients each being contained in a component arranged to be separate from each other.

Furthermore, it is preferred to also separate the initiator from the copper(II) salt, since one cannot exclude that small quantities of copper(I) salt are present, since the copper(II) salt may be present in an equal measure as the corresponding copper(I) salt, which together with the initiator could cause a slow initiation. This would result sometimes in at least partial polymerization (gelling) of the radically polymerizable compound and thus to a diminished storage stability. In addition, this would have a negative influence on the preset gel time of the composition, which would manifest in a gel time drift. This has the advantage that one can omit the use of high-purity and thus very expensive copper(II) salts.

In a possible embodiment of the invention, the previously described reaction resin composition is manufactured as a two-component system, wherein the radically polymerizable compound along with the hydraulically curing and/or polycondensable compound is contained in a first component and the water in a second component. The initiator system is thus broken down in such a manner that the copper(II) salt is completely contained either in the first component or in the second component. Accordingly, the reducing agent is contained in the respective other component to prevent a reduction of the copper(II) to copper(I). The initiator and regardless of it the nitrogen-containing ligand are either entirely contained in one of the two components or are each distributed in equal or different portions among both components. Preferably, the initiator and the copper(II) salt are contained in different components.

Depending on how the initiator system is divided among the two components, the initiator, the copper(II) salt, the reducing agent and the ligand shall be selected in such a manner that these are at least partially soluble or emulsifiable in the radically polymerizable compound or the water.

Thus, based on the just described embodiment, the following possibilities emerge illustratively for manufacturing the reaction resin composition, according to the invention, as a two-component system:

### i) Component I

radically polymerizable compound

hydraulically curable compound and/or polycondensable compound

copper(II) salt

if applicable, additives and fillers

### Component II

water

reducing agent

α-halocarboxylic acid ester

if applicable, additives and fillers

### ii) Component I

radically polymerizable compound

hydraulically curable compound and/or polycondensable compound

reducing agent

α-halocarboxylic acid ester

if applicable, additives and fillers

### Component II

water

copper(II) salt

if applicable, additives and fillers

In option (i), the copper(II) salt is selected in such a manner that it is at least partially soluble or emulsifiable in the radically polymerizable compound, and the reducing agent as well as the α-halocarboxylic acid ester are at least partially soluble or emulsifiable in water. To this end, the reducing agent is usually dissolved in water. The α-halocarboxylic acid ester can be dissolved or emulsified directly in water and be added as a solution or emulsion to the Component II composition, or it is dissolved or emulsified in the aqueous solution of the reducing agent.

In option (ii), this is correspondingly reversed, so that the copper(II) salt is selected in such a manner that it is at least partially soluble or emulsifiable in water and the reducing agent as well as the α-halocarboxylic acid ester are at least partially soluble or emulsifiable in the radically polymerizable compound.

The inventors observed that for certain nitrogen-containing ligands, particularly when using methacrylates as radically polymerizable compounds, a strong reaction occurred even without the presence of an initiator and reducing agent. Said reaction seems to occur when a ligand with tertiary amino groups is involved and the ligand contains at the nitrogen atom an alkyl residue with α-H atoms. In this case, the ligand is preferably to be kept separate from the radically polymerizable compound in Component II.

Depending on the nitrogen-containing ligand selected, the ligand and the copper(II) salt may be contained in a component over a longer period in a storage-stable manner, particularly for the preferred amines with primary amino groups.

In this way, a particularly preferred embodiment of the invention relates to a two-component system, which contains a reaction resin composition, which comprises a radically polymerizable compound, an α-halocarboxylic acid ester, a copper(II) salt, a nitrogen-containing ligand, a reducing agent, water, a hydraulically curing compound and/or polycondensable compound, an inhibitor, if applicable at least one reactive diluent and if applicable inorganic additive materials. A first component, component I, thereby contains the radically polymerizable compound, the hydraulically binding compound and/or polycondensable compound and the copper(II) salt, and a second component, component II, contains the water, the α-hydrocarboxylic acid ester, the reducing agent and the nitrogen-containing ligand, wherein the two components are stored separately from each other to prevent a reaction of the ingredients among each other prior to being mixed. The inhibitor, if applicable the reactive diluent as well as if applicable the inorganic additive materials, are distributed among both components.

The reaction resin composition may be contained in a cartridge, a container, a capsule or a foil pouch, which comprises two or more chambers that are separated from each other and in which the copper(II) salt and the reducing agent or the copper(II) salt and the reducing agent as well as the ligand are contained separately from each other in a reaction-inhibiting manner.

The reaction resin composition according to the invention is utilized primarily in the construction field, such as to repair concrete, as a polymer concrete, as a synthetic resin-based coating material, or as cold-curing street marking. They are particularly suitable for the chemical attachment of anchoring elements, such as anchors, reinforcement bars, screws, and the like, for use in boreholes, particularly boreholes in various substrates, particularly mineral substrates, such as those on the basis of concrete, aerated concrete, brickwork, lime sandstone, sandstone, natural stone and the like.

Another subject matter of the invention is the use of the reaction resin composition as a binding agent, particularly for attaching anchoring means in boreholes of various substrates and for construction-related adhesion.

The present invention also pertains to the use of the reaction resin mortar composition defined above for construction purposes, comprising the curing of the composition by mixing the copper(II) salt with the reducing agent or the copper(II) salt with the reducing agent and the ligand.

More preferably, the reaction resin mortar composition according to the invention is used for attaching threaded anchor rods, reinforcement bars, threaded sleeves, and screws in boreholes in various substrates, comprising the mixing of the copper(II) salt with the reducing agent or the copper(II) salt with the reducing agent and the ligand, inserting the mixture into the borehole, inserting the threaded anchor rods, the reinforcement bar, the threaded sleeves and the screws into the mixture into the borehole and curing the mixture.

The invention is explained in greater detail by means of a series of examples and comparisons. All examples support the scope of the claims. However, the invention is not limited to the specific embodiment shown in the examples.

### EMBODIMENTS

To manufacture the following sample formulations, the following ingredients were used:

| Abbreviation | Description |
|---|---|
| UMA-prepolymer I | Prepolymer of MDI and HPMA (DE4111828) |
| | with 35% BDDMA by weight |
| UMA-prepolymer II | Prepolymer of MDI and HPMA (DE4111828) |
| | with 35% HPMA by weight |
| Resin mixture I | 33.3% UMA-prepolymer I by weight + 33.3% |
| | HPMA by weight + 33.3% BDDMA by weight |
| MDI | Diphenylmethane diisocyanate |
| BDDMA | 1,4-butanedioldimethacrylate |
| HPMA | Hydroxypropyl methacrylate |
| THFMA | Tetrahydrofurfuryl methacrylate |
| BiBEE | α-bromoisobutyric acid ethyl ester or |
| | 2-bromisobutyric acid ethyl ester |
| Bipy | 2,2′-bipyridine |
| PMDETA | N,N,N′,N,″N″-pentamethyldiethylenetriamine |
| Sn-octoate | Sn(II)ethyl hexanoate |
| Tempol | 4-hydroxy-2,2,6,6-tetramethylpiperidinoxyl |
| Tween 80 | Polyoxyethylene sorbitan monooleate; Sigma- |
| | Aldrich |
| Span 80 | Sorbitan monooleate; Sigma-Aldrich |
| Betolin V30 | Polysaccharide-based anionic thickener; Wöllner |
| | GmbH & Co. KG |
| Aerosil 200 | Pyrogenic silicic acid; Evonic Resource |
| | Efficiency GmbH |
| Millisil W12 | Quartz powder; Quarzwerke GmbH |
| Quartz sand F12 | Quartz sand; Quarzwerke Österreich GmbH |
| Cab-O-Sil ® TS-720 | Pyrogenic silicic acid; Cabot Corp. |
| Secar 80 | Calcium-aluminum cement; Kerneos Inc. |
| HLB | Hydrophilic-lipophilic balance |

By means of the sample formulations, it is to be shown that the compositions according to the invention exhibit a sufficiently good curing behavior at least at room temperature (25° C.), which allows one to conclude that the compositions have the primary suitability to be used as cold-curing systems, for example in the field of chemical attachments.

### Determining Gel Time and Exothermicity

The gel time of the compositions is determined using a commercially available device (GEL-NORM®-Gel Timer) at a temperature of 25° C. To that end, all ingredients are mixed. This mixture is filled up to a height of 4 cm below the rim in a test tube, wherein the test tube is kept at a temperature of 25° C. (DIN 16945, DIN EN ISO 9396). A glass rod or a spindle is moved up and down in the resin at 10 strokes per minute. The gel time corresponds to the time at which the test tube can be raised by the oscillating rod. Additional tests have shown that the degree of curing at the gel point (measured by dynamic scanning calorimetry (DSC)) is constant within the measurement accuracy.

The heat generation of the sample is recorded against time. The evaluation is performed according to DIN 16945. The gel time is the time at which a temperature increase of 10K is achieved, in this case from 25° C. to 35° C.

The reactivity measurement (exothermicity) occurs according to DIN 16945.

Furthermore, the peak time and the peak temperature were measured. Peak time is the time until the maximum temperature was reached. Peak temperature is the maximum temperature that is measured in the gel timer during curing. It is a measure of the quality of the curing. The higher the peak temperature given the same gel time, the better the sample cures.

### Examples 1 to 5 (Initiator in the B-Component)

General composition of examples 1 to 5 having a mixing ratio of 3:1:

| A-component | B-component |
|---|---|
| Monomers | Water |
| Inhibitor | Reducing agent |
| Ligand | Initiator |
| Copper(II) salt | Tenside |
| Calcium-aluminate cement | Silicic acid |
| Silicic acid | Fillers |
| Fillers | |

For the examples 1 to 5, an A-component having the following composition was used:

| | % by weight |
|---|---|
| Resin mixture I | 40.29 |
| Copperbis(2-ethylhexanoate) | 0.15 |
| Tempol | 0.0243 |
| Bipy | 0.0334 |
| CAB-O-SIL ® TS-720 | 2.5 |
| Calcium-aluminate cement | 18.5 |
| Quartz sand | 38.5 |

The A-component was produced by the copperbis(2-ethylhexanoate), Tempol, the resin mixture and the bipy being mixed in a Speedmixer container for 1 hour at 300 rpm. Subsequently, pyrogenic silicic acid, quartz powder and then quartz sand were sequentially added and prior to each addition, the ingredient was stirred by hand. Lastly, mixing was done using a dissolver for 8 min. at 2,500 rpm, the mixture was poured into cartridges, and stored at 25° C.

### Example 1 (Ascorbic Acid as Reducing Agent)

The B-component had the following composition:

| | % by weight |
|---|---|
| L-ascorbic acid | 0.46 |
| Deionized water | 38.76 |
| Tween 80 | 0.75 |
| BiBEE | 0.50 |
| Aerosil 200 | 2.50 |
| Millisil W12 | 18.51 |
| Quartz sand F32 | 38.52 |

To manufacture the B-component, the L-ascorbic acid, deionized water, Tween 80 and BiEE were mixed in a Speedmixer container for 1 hour at 300 rpm. Subsequently, silicic acid, quartz powder, and then quartz sand were added, wherein after every addition, the mixture was stirred by hand. Lastly, the mixture was mixed using a dissolver for 8 min. at 2,500 rpm, poured into a cartridge, and stored at 25° C.

### Example 2 (Sodium Ascorbate as Reducing Agent)

The B-component had the following composition:

| | % by weight |
|---|---|
| Sodium ascorbate | 0.51 |
| Deionized water | 38.76 |
| Tween 80 | 0.75 |
| BiBEE | 0.507 |
| Aerosil 200 | 2.5 |
| Millisil W12 | 18.5 |
| Quartz sand F32 | 38.5 |

To manufacture the B-component, the sodium ascorbate, the deionized water, TWEEN 80 and the BiBEE were mixed in a Speedmixer container for 1 hour at 300 rpm. Subsequently, pyrogenic silicic acid, quartz powder and then quartz sand were added, wherein after every addition, the mixture was stirred by hand. Lastly, the mixture was mixed using a dissolver for 8 min. at 3,500 rpm, poured into a cartridge, and stored at 25° C.

### Example 3 (System with an Initiator Emulsion (HLB-13)

The B-component had the following composition:

| | % by weight |
|---|---|
| Sodium ascorbate | 0.52 |
| Deionized water | 39.00 |
| Tween 80 | 0.62 |
| Span 80 | 0.15 |
| Betolin V30 | 0.20 |
| BiBEE | 0.52 |
| Pyrogenic silicic acid | 1.62 |
| Millisil W12 | 18.62 |
| Quartz sand F33 [sic] | 38.75 |

To manufacture the B-component, the sodium ascorbate and the deionized water were mixed in a Speedmixer container for 1 hour at 300 rpm. Betolin V30 was added to this mixture and mixed for 4 to 5 hours at 300 rpm. The thusly obtained emulsifier mixture was mixed with BiBEE using a magnetic stirrer for 3 to 4 hours at 250-300 rpm. To this was added deionized water in a dropwise manner while stirring at 250-300 rpm until an O/W emulsion (22%/oil) was obtained. To this emulsion, a sodium ascorbate solution with xanthan was slowly added while stirring. The receiving emulsion was then stirred with a dissolver for 30 min. at 1,700 rpm. Subsequently, Aerosil 200, Millisil W12 and then quartz sand F32 were added sequentially, wherein after every addition, the mixture was stirred by hand. Lastly, the mixture was mixed using a dissolver for 8 min. at 3,500 rpm and poured into a cartridge.

### Example 4 (System with an Initiator Nano-Emulsion (HLB=15))

The B-component had the following composition

| | % by weight |
|---|---|
| Sodium ascorbate | 0.515 |
| Deionized, demineralized water | 38.76 |
| Tween 80 | 0.760 |
| 2-bromobutyric acid ethyl ester | 0.507 |
| Aerosil A200 | 2.5 |
| Millisil W12 | 18.49 |
| Quartz sand F32 | 38.47 |

To manufacture the B-component, the sodium ascorbate and the deionized water were mixed in a Speedmixer container for 10 minutes at 300 rpm. The thusly obtained emulsifier mixture was mixed with BiBEE using a magnetic stirrer for 3 to 4 hours at 250-300 rpm. To this was added the sodium ascorbate solution in a dropwise manner at a rate of 1 drop/30 sec until reaching 20% by weight, then 1 drop/1 min 30 sec until the emulsion became liquid, while stirring at 250-300 rpm. To this emulsion, a sodium ascorbate solution with xanthan was slowly added while stirring. The receiving emulsion was then stirred with a dissolver for 30 min. at 1,700 rpm. Subsequently, Aerosil 200, Millisil W12 and then quartz sand F32 were added, wherein after every addition, the mixture was stirred by hand. Lastly, the mixture was mixed using a dissolver for 8 min. at 3,500 rpm and poured into a cartridge.

### Example 5 (System with an Initiator Nano-Emulsion (HLB=15))

The B-component had the following composition:

| | % by weight |
|---|---|
| L-ascorbic acid | 0.46 |
| Deionized water | 38.78 |
| Tween 80 | 0.76 |
| BiBEE | 0.50 |
| Aerosil 200 | 2.50 |
| Millisil W12 | 18.50 |
| Quartz sand F32 | 38.50 |

To manufacture the B-component, the ascorbic acid and the deionized water were mixed in a Speedmixer container for 10 minutes at 300 rpm. The thusly obtained emulsifier mixture was mixed with BiBEE using a magnetic stirrer for 3 to 4 hours at 250-300 rpm. To this, the ascorbic acid solution was added in a dropwise manner while stirring at 250-300 rpm at a rate of 1 drop/30 s until reaching 20% by weight, then 1 drop/1 min 30 s until the emulsion became liquid. To this emulsion, an ascorbic acid solution was slowly added while stirring. Subsequently, Aerosil 200, Millisil W12 and then quartz sand F32 were sequentially added, wherein after every addition, the mixture was stirred by hand. Lastly, the mixture was mixed using a dissolver for 8 min. at 3,500 rpm and poured into a cartridge.

TABLE 1
Results of the gel time measurements of the freshly produced compositions and
the composition after storage over the indicated period

| | Example | | | | | | | | |
|---|---|---|---|---|---|---|---|---|---|
| | 1 | | 2 | | 3 | | 4 | | 5 |
| | fresh | 14 days | fresh | 2 days | fresh | 2 days | fresh | 2 days | 3 days |
| Gel time 5° C. | 29.92 | | | | | | | | |
| [min] | | | | | | | | | |
| Peak time | 28.93 | | | | | | | | |
| [min] | | | | | | | | | |
| Peak | 35.44 | | | | | | | | |
| temperature [° C.] | | | | | | | | | |
| Gel time 25° C. | 4.05 | 4.03 | 5.22 | 5.07 | 18.97 | 19.53 | 8.35 | 8.43 | 10.62 |
| [min] | | | | | | | | | |
| Peak time | 4.98 | 5.47 | 6.45 | 7.25 | 23.05 | 24.44 | 9.50 | 10.22 | 12.23 |
| [min] | | | | | | | | | |
| Peak | 82.20 | 76.97 | 77.59 | 75.13 | 58.86 | 57.96 | 77 | 72.93 | 71.60 |
| temperature [° C.] | | | | | | | | | |
| Gel time 40° C. | 0.03 | | | | | | | | |
| [min] | | | | | | | | | |
| Peak time | 1.60 | | | | | | | | |
| [min] | | | | | | | | | |
| Peak | 101.85 | | | | | | | | |
| temperature [° C.] | | | | | | | | | |

These results show that the system with the emulsified initiator have good curing and that the reactivity also does not change after storage.

### Examples 6 to 10 (Initiator in the A-Component)

General composition of examples 6 to 11 with a mixing ratio of 3:1:

| A-component | B-component |
|---|---|
| Monomers | Water |
| Initiator | Reducing agent |
| Inhibitor | Silicic acid |
| Ligand | Fillers |
| Copper(II) salt | |
| Calcium-aluminate cement | |
| Silicic acid | |
| Fillers | |

For examples 6 to 11, an A-component having the following composition was used:

| | % by weight |
|---|---|
| Resin mixture I | 40.21 |
| Copperbis(2-ethyl hexanoate) | 0.15 |
| BiBEE | 0.17 |
| Tempol | 0.02 |
| Bipy | 0.04 |
| Cab-O-Sil ® TS-720 | 2.50 |
| Secar 80 | 18.47 |
| Quartz sand F32 | 38.44 |

The A-component was produced by mixing the copperbis(2-ethylhexanoate), Tempol, the resin mixture, BiBEE and the bipy in a Speedmixer container for 1 hour at 300 rpm. Subsequently, Cab-O-Sil® TS-720, Millisil W12 and then quartz sand F32 were sequentially added and before every addition, the ingredient was mixed by hand. Lastly, mixing was done using a dissolver for 8 min. at 2500-3000 rpm, the mixture was poured into cartridges, and stored at 25° C.

The respective B-component was produced by deionized water and the reducing agent being stirred in a container by a magnetic stirrer at 300 rpm until a homogeneous solution was obtained. Then, for sample formulations 9 to 11, Betolin V30 was added. Subsequently, Aerosil 200, Millisil W12 and then quartz sand F32 were sequentially added and before every addition, the ingredient was stirred by hand. Lastly, mixing was done using a dissolver for 8 min. at 2500 rpm, the mixture was poured into cartridges, and stored at 25° C.

### Example 6

For example 6, a B-component having the following composition was used:

| pH = 4 | % by weight |
|---|---|
| 40% sodium bisulfate solution | 2.76 |
| Deionized water | 35.90 |
| Aerosil A200 | 3.72 |
| Millisil W12 | 18.70 |
| Quartz sand F32 | 38.92 |

### Example 7

For example 7, a B-component having the following composition was used:

| | % by weight |
|---|---|
| 40% sodium bisulfate solution | 5.33 |
| Deionized water | 34.72 |
| Aerosil A200 | 4.22 |
| Millisil W12 | 18.09 |
| Quartz sand F32 | 37.64 |

### Example 8

For example 8, a B-component having the following composition was used, wherein the pH value was adjusted using an NaOH solution:

| pH = 7 | % by weight |
|---|---|
| 40% sodium bisulfate solution | 5.37 |
| Deionized water | 34.99 |
| Aerosil A200 | 3.47 |
| Millisil W12 | 18.23 |
| Quartz sand F32 | 37.94 |

### Example 9

For example 9, a B-component having the following composition was used, wherein the pH value was adjusted using an NaOH solution:

| pH = 7 | % by weight |
|---|---|
| 40% sodium bisulfate solution + | 5.41 |
| 1% xanthan gum | |
| Deionized water | 35.20 |
| Betolin V30 | 0.35 |
| Aerosil A200 | 2.54 |
| Millisil W12 | 18.34 |
| Quartz sand F32 | 38.16 |

### Example 10 (Ascorbic Acid/Sodium Ascorbate (pH=2; 3; 5; 7))

For example 10, a B-component having the following composition was used, wherein pH values of 2, 3 and 5 were adjusted with an NaOH solution and a pH value of 7 was produced directly with sodium ascorbate.

| | % by weight |
|---|---|
| deionized water | 38.85 |
| Ascorbic acid | 0.46 |
| Betolin V30 | 0.39 |
| Aerosil A200 | 3.21 |
| Millisil W12 | 18.54 |
| Quartz sand F32 | 38.55 |

The B-component was produced, by deionized water (retain 20 mL) and Betolin V30 being stirred in a container by a magnetic stirrer for approximately 1.5 hours at 300-500 rpm. Subsequently, a solution of 20 mL deionized water and 2.86 g ascorbic acid were added and their pH value was adjusted with a sodium solution. This solution was added to a xanthan gum solution and mixed for 5 minutes at 300 rpm. Subsequently, Aerosil 200, Millisil W12 and then quartz sand F32 were sequentially added and before every addition, the ingredient was stirred by hand. Lastly, mixing was done using a dissolver for 8 min. at 2500 rpm, the mixture was poured into cartridges, and stored at 25° C.

TABLE 2
Results of the gel time measurement of the freshly produced compositions and the
composition from example 10, in which the composition was adjusted to various
pH values.

| | Example | | | | | | | |
|---|---|---|---|---|---|---|---|---|
| | | | | | 10 | | | |
| | 6 | 7 | 8 | 9 | pH = 2 | pH = 3 | pH = 5 | pH = 7 |
| Gel time 25° C. [min] | 1.43 | 0.95 | 1.82 | 2.2 | 3.77 | 3.5 | 3.42 | 3.48 |
| Peak time [min] | 3.10 | 2.42 | 3.87 | 4.57 | 5.03 | 4.70 | 4.35 | 4.62 |
| Peak temperature | 74.47 | 78.47 | 73.05 | 67.47 | 77.43 | 76.67 | 79.84 | 77.95 |
| [° C.] | | | | | | | | |

These results show that the systems with the initiator in the A-component also cure well and quickly (short gel time, high exothermicity), and that the pH value (system 10) has no appreciable influence on the curing.

### Examples 11 to 15 (Reducing Agent in A-Component, Cu(11) Salt in B-Component)

General composition of examples 12 to 16 at a mixing ratio of 3:1:

| A-component | B-component |
|---|---|
| Monomers | Water |
| Initiator | Copper(II) salt |
| reducing agent | Silicic acid |
| Inhibitor | Fillers |
| Ligand | |
| Calcium-aluminate cement | |
| Silicic acid | |
| Fillers | |

For examples 11 to 15, an A-component having the following composition was used:

The A-component was produced by mixing the reducing agent, the ligand, the resin mixture and the Tempol in a container for 1 to 3 hours at 300 rpm. Subsequently, Cab-O-Sil TS-720, Secar 80 and then quartz sand F32 were sequentially added and before every addition, the ingredient was stirred by hand. Lastly, mixing was done using a dissolver for 8 min. at 3,500 rpm, the mixture was poured into cartridges, and stored at 25° C.

The B-component was produced by stirring deionized water and the copper(II) salt in a container using a magnetic stirrer for approximately 5 minutes at 300 rpm. Then optionally, the Betolin V30 was added over 3 to 5 hours at 300 rpm. Subsequently, Aerosil 200, Millisil W12 and then quartz sand F32 were sequentially added, and before every addition, the ingredient was stirred by hand.

Lastly, mixing was done using a dissolver for 8 min. at a maximum speed of 800 rpm, the mixture was poured into cartridges, and stored at 25° C.

### Example 11

For example 11, an A-component and a B-component having the following composition were used:

% by weight

A-component

| | |
|---|---|
| Resin mixture I | 40.11 |
| Tempol | 0.01 |
| Bipy | 0.03 |
| BiBEE | 0.17 |
| Sn-octoate | 0.35 |
| Cab-O-SilTS-720 | 2.49 |
| Secar 80 | 18.45 |
| Quartz sand F32 | 38.39 |

B-component:

| | |
|---|---|
| Deionized water | 39.22 |
| Copper(II) sulfate, | 0.21 |
| Betolin V80 | 0.39 |
| Aerosil 200 | 2.53 |
| Millisil W12 | 18.71 |
| Quartz sand F32 | 38.94 |

### Example 12

For example 12, an A-component and a B-component having the following composition were used:

% by weight

A-component:

| | |
|---|---|
| Resin mixture I | 40.10 |
| PMEDTA | 0.04 |
| BiBEE | 0.17 |
| Sn-octoate | 0.35 |
| Cab-O-Sil ® TS-720 | 2.49 |
| Secar 80 | 18.46 |
| Quartz sand F32 | 38.39 |

B-component:

| | |
|---|---|
| Deionized water | 38.45 |
| Copper(II) sulfate, | 0.20 |
| Betolin V80 | 0.38 |
| Aerosil 200 | 4.45 |
| Millisil W12 | 18.35 |
| Quartz sand F32 | 38.17 |

### Example 13

For example 13, an A-component and a B-component having the following composition were used:

% by weight

A-component:

| | |
|---|---|
| Resin mixture I | 40.10 |
| Bipy | 0.04 |
| BiBEE | 0.17 |
| Sn-octoate | 0.36 |
| Cab-O-Sil ® TS-720 | 2.49 |
| Secar 80 | 18.45 |
| Quartz sand F32 | 38.39 |

B-component:

| | |
|---|---|
| Deionized water | 39.19 |
| Copper(II) bromide | 0.29 |
| Betolin V80 | 0.39 |
| Aerosil 200 | 2.53 |
| Millisil W12 | 18.70 |
| Quartz sand F32 | 38.90 |

### Example 14

For example 14, an A-component and a B-component having the following composition were used:

% by weight

A-component:

| | |
|---|---|
| Resin mixture I | 40.10 |
| Bipy | 0.04 |
| BiBEE | 0.17 |
| Sn-octoate | 0.36 |
| Cab-O-Sil ® TS-720 | 2.49 |
| Secar 80 | 18.45 |
| Quartz sand F32 | 38.39 |

B-component:

| | |
|---|---|
| Deionized water | 39.31 |
| Copper(II) bromide | 0.28 |
| Aerosil 200 | 3.53 |
| Millisil W12 | 18.57 |
| Quartz sand F32 | 38.65 |

### Example 15

For example 15, an A-component and a B-component having the following composition were used:

% by weight

A-component:

| | |
|---|---|
| Resin mixture I | 40.18 |
| Bipy | 0.04 |
| BiBEE | 0.02 |
| 5,6-lsopropylidene-L-ascorbic acid | 0.19 |
| Cab-O-Sil ® TS-720 | 2.51 |
| Secar 80 | 18.49 |
| Quartz sand F32 | 38.57 |

B-component:

| | |
|---|---|
| Deionized water | 39.19 |
| Copper(II) bromide | 0.29 |
| Betolin V80 | 0.39 |
| Aerosil 200 | 2.53 |
| Millisil W12 | 18.70 |
| Quartz sand F32 | 38.90 |

TABLE 3
Results of the gel time measurements for freshly produced
compositions and the composition from example 11 after
3 days storage over the indicated period

| | Example | | | | | |
|---|---|---|---|---|---|---|
| | 11 | | 12 | 13 | 14 | 15 |
| | fresh | 3 days | fresh | fresh | fresh | fresh |
| Gel time 25° C. [min] | 8.82 | 10.40 | 9.87 | 3.53 | 9.72 | 3.65 |
| Peak time [min] | 10.18 | 11.63 | 13.30 | 4.72 | 12.2 | 5.93 |
| Peak temperature [° C.] | 78.05 | 76.27 | 68.93 | 76.36 | 71.86 | 73.92 |

These results show that these systems, which use water-soluble Cu(II) salts in the B-component and resin-soluble reducing agents in the A-component, also have good curing (short gel time, strong exothermicity).

### Examples 16 to 19 (Ligand in B-Component)

General composition of examples 17 to 19 having a mixing ratio of 3:1:

| A-component | B-component |
|---|---|
| Monomers | Water |
| Initiator | Copper(II) salt |
| reducing agent | Ligand |
| Inhibitor | Silicic acid |
| Calcium-aluminate cement | Fillers |
| Silicic acid | |
| Fillers | |

### Example 16

For example 16, an A-component and a B-component having the following composition were used:

% by weight

A-component:

| | |
|---|---|
| Resin mixture I | 40.11 |
| Tempol | 0.02 |
| BiBEE | 0.17 |
| Sn-octoate | 0.35 |
| Cab-O-Sil TS-720 | 2.49 |
| Secar 80 | 18.45 |
| Quartz sand F32 | 38.40 |

B-component:

| | |
|---|---|
| deionized water | 38.73 |
| Copper(II) sulfate, anhydrous | 0.20 |
| Bipy | 0.16 |
| Betolin | 0.58 |
| Aerosil A200 | 2.63 |
| Millisil W12 | 18.98 |
| Quartz sand F32 | 38.72 |

### Example 17

For example 17, an A-component and a B-component having the following composition were used:

% by weight

A-component:

| | |
|---|---|
| Resin mixture I | 40.11 |
| BiBEE | 0.17 |
| Sn-octoate | 0.31 |
| Cab-O-Sil TS-720 | 2.49 |
| Secar 80 | 18.46 |
| Quartz sand F32 | 38.41 |

B-component:

| | |
|---|---|
| deionized water | 39.58 |
| Copper(II) sulfate, anhydrous | 0.21 |
| PMEDTA | 0.12 |
| Aerosil A200 | 2.22 |
| Millisil W12 | 18.78 |
| Quartz sand F32 | 38.99 |

### Example 18

For example 18 an A-component and a B-component having the following composition were used:

% by weight

A-component:

| | |
|---|---|
| Resin mixture I | 40.12 |
| BiBEE | 0.17 |
| Sn-octoate | 0.35 |
| Cab-O-Sil TS-720 | 2.49 |
| Secar 80 | 18.46 |
| Quartz sand F32 | 38.41 |

B-component:

| | |
|---|---|
| deionized water | 39.02 |
| Copper(II) sulfate, anhydrous | 0.27 |
| PMEDTA | 0.13 |
| Aerosil A200 | 3.22 |
| Millisil W12 | 18.63 |
| Quartz sand F32 | 38.74 |

### Example 19 (Water-Soluble Monomer in B Substitutes Part of the Water)

For example 20 [sic], an A-component and a B-component having the following composition were used:

% by weight

A-component:

| | |
|---|---|
| UMA Prepolymer II | 20.62 |
| HPMA | 6.19 |
| 1,4-BDDMA | 13.40 |
| Copper(II)-2-ethylhexanoate | 0.15 |
| BiBEE | 0.17 |
| Bipy | 0.04 |
| TEMPOL | 0.04 |
| Cab-O-Sil TS-720 | 2.50 |
| Secar 80 | 18.45 |
| Quartz sand F32 | 38.44 |

B-component:

| | |
|---|---|
| Deionized water | 19.40 |
| L-ascorbic acid | 0.47 |
| MPEG-35Q-methacrylate | 19.41 |
| Ultragel 300 | 0.40 |
| Aerosil 200 | 3.00 |
| Millisil W12 | 19.10 |
| Quartz sand F32 | 38.22 |

TABLE 4
Results of the get time measurements after
the composition was stored for 2 days

| Example | 16 | 17 | 18 | 19 |
|---|---|---|---|---|
| Gel time 25° C. [min] | 18.17 | 10 | 10.57 | 4.5 |
| Peak time [min] | 19.60 | 12.80 | 13.08 | 5.5 |
| Peak temperature [° C.] | 77.18 | 75.64 | 70.29 | 87 |

These results show that the ligand can definitely also be stored in the B-component, and that if necessary some of the water can be exchanged for water-soluble monomers (which could simultaneously act as a tenside if necessary).

### Determining the Extraction Resistance

Each of 3 M12×72 anchor rods are set in C20/25 concrete into dry and cleaned boreholes having a diameter of 14 mm and are pulled out until failure after 24 hours of curing (central tension) and the following load values are determined for the test temperatures indicated in Table 5 (mean values of 3 measurements).

### Determining the Internal Strength

The extraction test is conducted as for determining the extraction strength, however one uses steel sleeves with a profiled hole, which the borehole simulates. One sets 5 sleeves with M8×100 anchor rods and conducts a tensile test using a Zwick tensile test machine until the anchor fails. By this experiment, one can exclude the influence of the concrete borehole wall on the mortar.

TABLE 5
Results of determining the extraction strength

| Load values | Examples | | | | |
|---|---|---|---|---|---|
| [N/mm²] | 1 | 2 | 3 | 4 | 5 |
| Ref. | 8.1 | 4.1 | 1.5 | 3.4 | 3.6 |
| −5° C. | 8.9 | | | | |
| +5° C. | 5.2 | | | | |
| +40° C. | 9.9 | | | | |

| | Examples | | | | | |
|---|---|---|---|---|---|---|
| Load values | 10 | 10 | 10 | 10 | | |
| [N/mm²] | (pH = 2) | (pH = 3) | (pH = 5) | (pH = 7) | 11 | 19 |
| Ref. | 6 | 7.0 | 6.6 | 6.8 | 3.1 | 9 |
| −5° C. | | | | | 0.3 | |
| +5° C. | | | | | | |
| +40° C. | | | | | 3.3 | 12.5 |

TABLE 6
Results of the internal strength assessments

| | Example 1 | Example 2 |
|---|---|---|
| Internal strength σ [N/mm²] | 10.65 | 6.11 |

The results show that appreciable failure load values can be achieved with the compositions, so that the compositions have a primary suitability as chemical anchors.

1-20. (canceled)

21. Reaction resin composition having
A radically polymerizable compound,
An initiator system, which contains
An α-halocarboxylic acid ester and
A catalyst system, which comprises
A copper(II) salt
A reducing agent and
At least one nitrogen-containing ligand
A hydraulically curing and/or polycondensable compound and
Water.

22. Reaction resin composition according to claim 21, wherein the reducing agent is selected from the group consisting of ascorbic acid and its salts or derivatives, saccharides with a reducing effect, tin(II) carboxylates, hydroxylamines, phenolic reducing agents, catecholes, hydroxylamines [sic] and combinations thereof.

23. Reaction resin composition according to claim 21, wherein the α-halocarboxylic acid ester is wholly or partially soluble or emulsifiable in water.

24. Reaction resin composition according to claim 21, wherein the α-halocarboxylic acid ester is selected among compounds having the general formula (I): 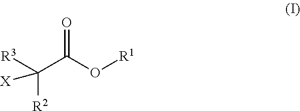
in which
X means chlorine, bromine or iodine, preferably chlorine or bromine, most preferably bromine;
R¹ stands for a straight-chained or branched, if applicable substituted C₁-C₂₀ alkyl group, a polyalkyleneoxide group or an aryl group; or preferably a C₁-C₁₀ alkyl group, a polyalkylene oxide chain or group or an aryl group; or for the residue of an acylated, branched, trivalent alcohol, the residue of a completely or partially acylated, linear penta- or hexavalent alcohol, the residue of a completely or partially acylated, linear or cyclic C₄-C₆ aldoses or C₄-C₆ ketoses or the remainder of a completely or partially acylated disaccharide, and isomers of these compounds;
R² and R³ stand, independently of each, for hydrogen, a C₁-C₂₀ alkyl group, a C₃-C₈ cyclo-alkyl group, a C₂-C₂₀ alkenyl or alkinyl group, oxiranyl group, glycidyl group, aryl group, heterocyclyl group, aralkyl group or aralkenyl group.

25. Reaction resin composition according to claim 24, wherein the copper(II) salt is selected from the group that consists of Cu(II)(PF₆)₂, CuX₂, where X=CI, Br, I, Cu(OTf)₂ and Cu(ll) carboxylates.

26. Reaction resin composition according to claim 21, wherein the nitrogen-containing ligand contains two or more nitrogen atoms and can form with copper(I) a chelate complex.

27. Reaction resin composition according to claim 26, wherein the nitrogen-containing ligand is selected among amino compounds with at least two primary, secondary and/or tertiary amino groups or amino compounds with at least two heterocyclic nitrogen atoms.

28. Reaction resin composition according to claim 21, wherein the radically polymerizable compound is an unsaturated polyester resin, a vinyl ester resin and/or a vinyl ester urethane resin.

29. Reaction resin composition according to claim 21, wherein the radically polymerizable compound is a (meth)acrylate-functionalized resin and the α-halocarboxylic acid ester is an α-halocarboxylic acid ester of isobutyric acid or propanoic acid.

30. Reaction resin composition according to claim 21, wherein the hydraulically curing compound is selected from cement and/or gypsum.

31. Reaction resin composition according to claim 21, wherein the polycondensable compound is selected from silicatic polycondensable compounds.

32. Reaction resin composition according to claim 21, wherein the composition also contains at least one other ingredient, which is selected from the group that consists of inhibitors, additives and fillers.

33. Reaction resin composition according to claim 21, wherein the copper(II) salt is separated in a reaction-inhibiting manner from the reducing agent and the water is separated in a reaction-inhibiting manner from the hydraulically curing and/or polycondensable compound.

34. Reaction resin composition according to claim 33, wherein the copper(II) salt is also separated in a reaction-inhibiting manner from the α-halocarboxylic acid ester.

35. Two- or multi-component system comprising a reaction resin composition according to claim 21.

36. Two- or multi-component system according to claim 35, wherein the copper(II) salt is separated in a reaction-inhibiting manner from the reducing agent and the water is separated in a reaction-inhibiting manner from the hydraulically curing and/or polycondensable compound.

37. Two- or multi-component system according to claim 36, wherein the copper(II) salt is also separated in a reaction-inhibiting manner from the α-halocarboxylic acid ester.

38. Two- or multi-component system according to claim 36, wherein the radically polymerizable compound and the hydraulically curing and/or polycondensable compound are contained in a first component and the water is contained in a second component, and the copper(II) salt is contained in the first component and the reducing agent is contained in the second component, or the copper(II) salt is contained in the second component and the reducing agent is contained in the first component.

39. Two-component system according to claim 38, wherein the ligand the initiator are each contained independently of each other in a component or divided among both components.

40. A method of using the reaction resin composition according to claim 21 for construction purposes, comprising curing the composition by mixing the copper(II) salt with the reducing agent or the copper(II) salt with the reducing agent and the ligand.

41. A method of using the two- or multi-component system according to claim 35 for construction purposes, comprising containing the radically polymerizable compound along with the hydraulically curing and/or polycondensable compound in a first component and containing water in a second component, wherein the copper(II) salt is completely contained either in the first component or in the second component.
